(19) United States
(12) Patent Application Publication
(10) Pub. No.: US 2016/0130951 A1
(43) Pub. Date: May 12, 2016

(54) COOLING FOR TURBINE BLADE PLATFORM-AEROFOIL JOINTS

(71) Applicant: ALSTOM Technology Ltd., Baden (CH)

(72) Inventors: Marc HENZE, Wettingen (CH); Joerg KRÜCKELS, Birmenstorf (CH); Laura BOGDANIC, Wettingen (CH)

(73) Assignee: ALSTOM TECHNOLOGY LTD., Baden (CH)

(21) Appl. No.: 14/934,932

(22) Filed: Nov. 6, 2015

(30) Foreign Application Priority Data
Nov. 12, 2014 (EP) 14192815.0

(51) Int. Cl. F01D 5/18; F01D 11/00; F01D 5/14

(52) U.S. Cl. CPC F01D 5/187; F01D 5/147; F01D 11/005; F05D 2260/2212; F05D 2240/30; F05D 2220/32; F05D 2240/81; F05D 2240/55

(57) ABSTRACT

The invention concerns a turbine blade for a gas turbine having a platform part and an aerofoil part. The platform part includes a platform surface arranged to be attached to a corresponding aerofoil surface of the aerofoil part. The turbine blade further includes a cooling duct for cooling the platform and aerofoil surfaces, the cooling duct having at least one cavity in the platform surface and at least one cavity in the corresponding aerofoil surface, and the platform and aerofoil surface cavities are aligned such that when the platform surface and the aerofoil surface are touching, the cooling duct remains open. This provides a reliable cooling of both the platform and aerofoil surfaces.

### TECHNICAL FIELD

This invention relates to cooling for blades for gas turbines, and particularly to providing a cooling system for cooling the join between platform and aerofoil surfaces.

### BACKGROUND OF THE INVENTION

In the process of building gas turbines, it is often necessary to join together two or more pieces to create a built part, such as the platform and aerofoil of a turbine blade. In joining these pieces together, it is not necessarily possible to achieve a perfect fit and a sealed joint, and it is likely that a distinct gap between the single pieces of the built part will remain. In some areas in gas turbines, engine operation and/or different thermal expansion may cause the gap between pieces to open or close. For example, a small gap may appear between the platform part and aerofoil part, with the result that hot gas may enter the gap between two parts, reducing part lifetime. It is therefore critical that parts are kept sufficiently cool. It has been appreciated that it would be desirable to improve the turbine blade design in light of these considerations.

### SUMMARY OF THE INVENTION

The invention is defined in the appended independent claims to which reference should now be made. Advantageous features of the invention are set forth in the dependent claims.

According to a first aspect of the invention, there is provided a turbine blade for a gas turbine, comprising a platform part and an aerofoil part, the platform part comprising a platform surface arranged to be attached to a corresponding aerofoil surface of the aerofoil part, further comprising a cooling duct for cooling the platform and aerofoil surfaces, the cooling duct comprising at least one cavity in the platform surface and at least one cavity in the corresponding aerofoil surface, and the platform and aerofoil surface cavities are aligned such that when the platform surface and aerofoil surface are touching, the cooling duct remains open. This provides a reliable cooling means that cools both the platform and aerofoil surfaces, as it avoids blockage of the cooling duct that might appear during engine use, be it a steady state blockage or a transient blockage. A coolant flow is therefore generated that can cool both the platform surface and the aerofoil surface, even during complete closure of the gap between the two parts.

Advantageously, the cooling duct additionally comprises at least one inlet duct or inlet groove. Advantageously, the cooling duct additionally comprises at least one outlet duct or outlet groove. Advantageously, the turbine blade additionally comprises at least one turbulator in at least one of the cavities. This provides for a turbulent air flow and can improve cooling.

Advantageously, the platform part is made from a different material to the aerofoil part. Advantageously, the turbine blade comprises a bi-cast joint between the platform part and the aerofoil part. Advantageously, the turbine blade comprises a seal extending between the platform part and the aerofoil part, for at least substantially stopping ingress of hot gas between the platform part and the aerofoil part. Advantageously, the turbine gas additionally comprises a release means to allow a cooling fluid to flow through the seal. This allows for cooling air to exit into the hot gas flow whilst minimising hot gas flow in the opposite direction.

In a further aspect of the invention, a gas turbine is provided comprising a turbine blade as described above.

### BRIEF DESCRIPTION OF THE DRAWINGS

An embodiment of the invention will now be described by way of example only and with reference to the accompanying drawings in which:

FIG. 1 shows a partial cross-section view of part of a turbine blade according to the present invention;

FIG. 2 shows a partial view of an aerofoil part as shown in FIG. 1.

FIG. 3 shows a cross-section view of part of a turbine blade according to an embodiment of the invention.

FIG. 4 shows several different embodiments of cavities according to the invention.

FIGS. 5A and 5B show an exemplary turbine blade in which the present invention could be used.

FIG. 6 shows a partial cross-section view of a turbine blade according to an embodiment of the invention.

### DETAILED DESCRIPTION OF THE PREFERRED EMBODIMENTS

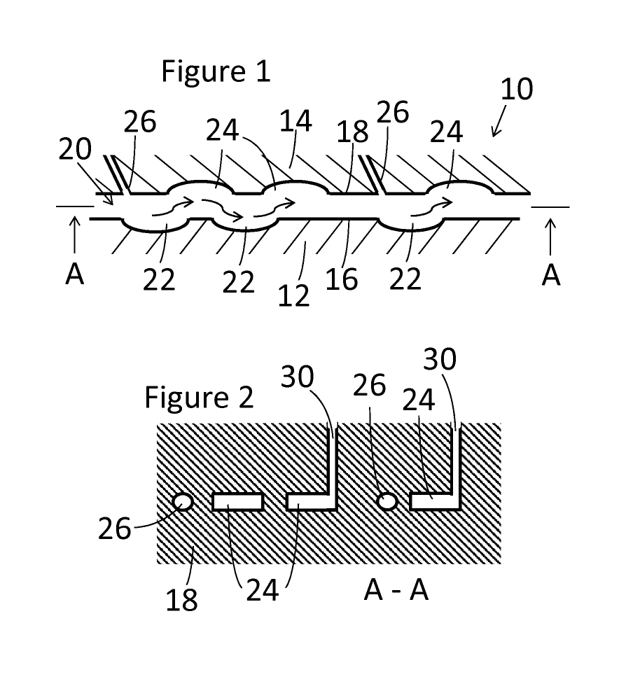

FIG. 1 shows a turbine blade 10 for a gas turbine, comprising a platform part 12 and an aerofoil part 14. The platform part comprises a platform surface 16 arranged to be attached to a corresponding aerofoil surface 18 of the aerofoil part. The turbine blade 10 also comprises a cooling duct 20 for cooling the platform and aerofoil surfaces, and the cooling duct comprises at least one cavity 22 in the platform surface 16 and at least one cavity 24 in the corresponding aerofoil surface 18. The platform and aerofoil surface cavities are aligned such that when the platform surface 16 and the aerofoil surface 18 are touching, the cooling duct 20 remains open. In the embodiment shown in FIG. 1, inlet ducts 26 are also provided; further details on alternatives to this are provided below.

FIG. 2 shows the aerofoil part 14 shown in FIG. 1. As in FIG. 1, the cavities 24 and inlet ducts 26 can be seen. In addition, exit/outlet grooves 30 can now be seen. These allow the cooling fluid (typically air) to flow out of the blade. Exit grooves are optional; further options are discussed below.

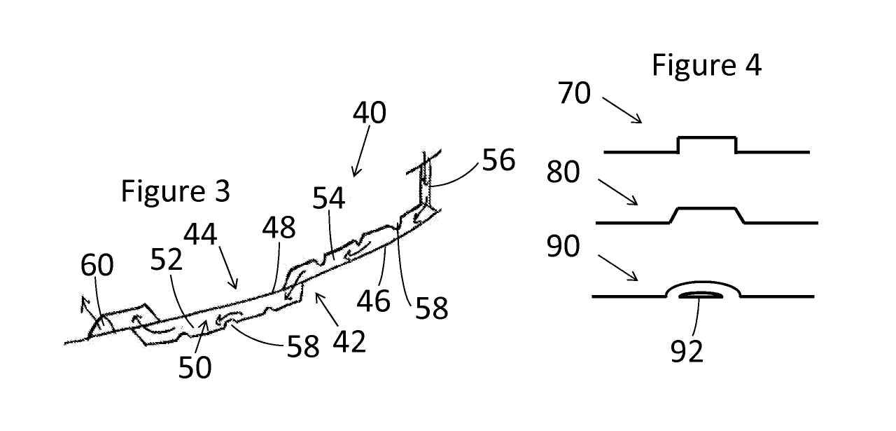

FIG. 3 shows an embodiment of the invention. In FIG. 3, a turbine blade 40 is shown with a platform part 42 and an aerofoil part 44. The platform surface 46 and aerofoil surface 48 are shown touching one another in FIG. 3. A cooling duct 50 is provided, comprising a cavity 52 in the platform part and a cavity 54 in the aerofoil part. Within the cooling duct optional turbulators 58 are provided. These can help to maximise cooling by mixing the flow. An inlet duct 56 and an outlet 60 (for example an outlet groove or an outlet duct) are also provided.

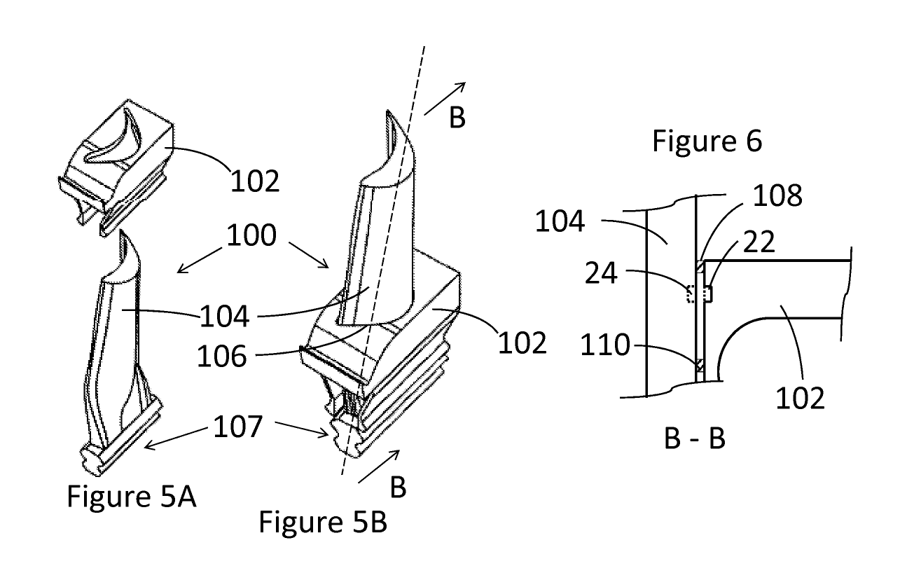

The invention will now be described in the context of a rotating blade, but can equally well be provided in a stationary blade (a vane). FIG. 5 shows an example of a turbine blade 100 comprised of two parts, platform part 102 and aerofoil part 104, in which the current invention can be included. The platform part and aerofoil part are slotted together as shown in FIG. 5B, and a resulting join 106 is formed. Preferably, this is a hybrid assembly, with the platform part and aerofoil part made of different materials, for example different alloys. A blade root (fir tree) structure 107 is also shown in this example and is optional.

An example is shown in FIG. 6, showing roughly what the blade of FIG. 5 would look like with the invention implemented (along the line B-B). Typically, the platform part 102 and aerofoil part 104 will be joined by a bi-cast joint (not shown), and a seal 108 will then be placed over the join. Despite the joint, the two parts might move relative to one another under engine conditions and/or under thermal stress, especially if the two parts are made of different materials. This means that the join may be left with a gap between the two parts, and hot gas may enter the join despite the seal. Preferably the seal extends between the platform part and the aerofoil part, for at least substantially stopping ingress of hot gas between the platform part and the aerofoil part. The seal is normally placed at or in the edge of the gap between the platform part and the aerofoil part. One or more release means may be provided to allow a cooling fluid to flow through the seal. Alternatively or additionally to a release means, a positive pressure margin from the coolant to the hot gas should be maintained, for example by feeding coolant at high internal pressure and discharging at a lower external pressure. This would further minimise hot gas ingestion, improving the durability of the joint. Another seal 110 may be placed towards the root end of the aerofoil part, to seal the gap at the other side of the cooling duct. The example of FIG. 6 is described as being in a rotating blade as in FIG. 5 but, as with the other described embodiments, could equally well be implemented in other rotating blades or in a stationary blade.

The platform part 12 may be made of the same material as aerofoil part 14. This invention is particularly suitable for hybrid parts, where the platform part and aerofoil part are made of different materials and the thermal expansion coefficients of the two parts may be different. In a preferred embodiment the platform part and aerofoil part are therefore made of different materials.

The platform surface 16 and the aerofoil surface 18 may be planar or substantially planar, but may also be curved, such as those shown in FIG. 3 and FIG. 5.

The cooling duct 20 may be a single path for a cooling fluid, or may comprise multiple paths extending in various directions across the surfaces. The platform and aerofoil surface cavities are aligned so that they overlap such that when the platform surface and aerofoil surface are touching, the cooling duct that the platform and surface cavities form remains open. This overlap between the cavities allows for the cooling duct to maintain a fluid path even when the platform surface and aerofoil surface are touching. The cooling duct may be part of a larger cooling system, such as a turbine blade cooling system.

The cavities 22, 24 may be various different shapes. In FIG. 1, the cavities are shown with a semi oval cross-section, but various other cross-sections are possible, such as cavities 70, 80 and 90 in FIG. 4. Cavity 90 is partially covered by a portion 92; cavities made in this way can provide more efficient cooling. There may be one or more cavities in each of the aerofoil part and the platform part.

In FIG. 2, the cavities (or grooves) are shown with an oblong cross section with respect to the surface 18, but various other cross-sectional areas could be used, such as oval, circular, or irregularly shaped cross-sections. For example, the turbulators may extend in such a way that they affect the edges of the surface cross-section. Different shaped cavities could be provided in different places on the surfaces; the cavities need not all the same shape and size.

The inlet duct or ducts 26 (or holes) may be provided in various ways, and may be disposed in the platform part, the aerofoil part, or both. Alternatively, there may be no bespoke inlet means at all, with the inlet provided by an integral part of a blade cooling system. For example, the inlet may be provided by a cooling duct that is part of a cooling system for other parts of the blade, and the duct simply passes through a cavity. A portion of the cooling fluid that is flowing through the cooling system cooling duct then ends up flowing through the cooling duct of the present invention.

Similar flexibility exists in the outlet groove or grooves 30, which may be disposed in the platform part, the aerofoil part, or both. Instead of grooves, ducts could be provided, and in some embodiments there could be no separate outlet at all, with the cavities extending all the way to the outside edge of the blade. The outlet may eject the cooling fluid into the hot gas flow, or it may be directed elsewhere for further cooling.

The turbulators 58 may be various shapes, such as ribs, pedestals (pins) or islands disposed within the flow. These turbulators act as heat transfer coefficient enhancing features, improving heat transfer. One or more turbulators may be provided in any given cavity.

Various modifications to the embodiments described are possible and will occur to those skilled in the art without departing from the invention which is defined by the following claims.

REFERENCE SIGNS

| | |
|---|---|
| 10 | turbine blade |
| 12 | platform part |
| 14 | aerofoil part |
| 16 | platform surface |
| 18 | aerofoil surface |
| 20 | cooling duct |
| 22 | cavity |
| 24 | cavity |
| 26 | inlet duct |
| 30 | exit groove |
| 40 | turbine blade |
| 42 | platform part |
| 44 | aerofoil part |
| 46 | platform surface |
| 48 | aerofoil surface |
| 50 | cooling duct |
| 52 | cavity |
| 54 | cavity |
| 56 | inlet duct |
| 58 | turbulator |
| 60 | outlet |
| 100 | turbine blade |
| 102 | platform part |
| 104 | aerofoil part |
| 106 | join |
| 107 | blade root |
| 108 | seal |
| 110 | seal |

1. A turbine blade for a gas turbine, comprising a platform part and an aerofoil part, the platform part comprising a platform surface arranged to be attached to a corresponding aerofoil surface of the aerofoil part, further comprising a cooling duct for cooling the platform and aerofoil surfaces, the cooling duct comprising at least one cavity in the platform surface and at least one cavity in the corresponding aerofoil surface, and
the platform and aerofoil surface cavities are aligned such that when the platform surface and the aerofoil surface are touching, the cooling duct remains open.

2. The turbine blade of claim 1, wherein the cooling duct additionally comprises at least one inlet duct or inlet groove.

3. The turbine blade of claim 1, wherein the cooling duct additionally comprises at least one outlet duct or outlet groove.

4. The turbine blade of claim 1, comprising at least one turbulator in at least one of the cavities.

5. The turbine blade of claim 1, in which the platform part is made from a different material to the aerofoil part.

6. The turbine blade of claim 1, additionally comprising a bi-cast joint between the platform part and the aerofoil part.

7. The turbine blade of claim 1, additionally comprising a seal extending between the platform part and the aerofoil part, for at least substantially stopping ingress of hot gas between the platform part and the aerofoil part.

8. The turbine blade of claim 7, additionally comprising a release means to allow a cooling fluid to flow through the seal.

9. A gas turbine comprising a turbine blade as claimed in any claim 1.
